(19) United States
(12) Patent Application Publication
(10) Pub. No.: US 2025/0075352 A1
(43) Pub. Date: Mar. 6, 2025

(54) NATURAL MOLECULE-DERIVED ORGANIC MATERIAL-METAL COMPLEX THIN FILM PROTECTION LAYER AND METHOD FOR PRODUCING SAME

(71) Applicant: Research & Business Foundation SUNGKYUNKWAN UNIVERSITY, Suwon-si (KR)

(72) Inventors: Jung Kyu KIM, Suwon-si (KR); Ki Hyun KIM, Suwon-si (KR); Won Tae HONG, Suwon-si (KR)

(73) Assignee: Research & Business Foundation SUNGKYUNKWAN UNIVERSITY, Suwon-si (KR)

(21) Appl. No.: 18/789,351

(22) Filed: Jul. 30, 2024

(30) Foreign Application Priority Data
Aug. 28, 2023 (KR) 10-2023-0112528

(51) Int. Cl. C25B 11/087; C25B 1/04; C25B 1/55; C25B 11/095

(52) U.S. Cl. CPC C25B 11/087; C25B 1/04; C25B 1/55; C25B 11/095

(57) ABSTRACT

An embodiment of the disclosure provides an organic-metal composite thin film photoelectrode including a natural molecule-derived organic material-metal complex protection layer and a method for producing the same. An organic-metal composite thin film photoelectrode according to an embodiment of the disclosure has an effect of securing effective photogenerated charge dynamics due to improved optical, electrical, and chemical characteristics by introducing an organic material-metal complex produced through controlled organic material functional group-positive metal ion interaction into a thin film protection layer, thereby improving light absorption efficiency, controlling surface active sites, and securing excellent stability.

### CROSS-REFERENCE TO RELATED APPLICATION(S)

This application claims priority to Korean Patent Application No. 10-2023-0112528, filed on Aug. 28, 2023, the entire disclosure of which is incorporated herein for all aspects.

### BACKGROUND

The disclosure relates to a photoelectrode including a thin film protection layer using an organic material derived from a natural product and a metal complex, and a method for producing the same.

Metal oxide-based semiconductor materials are abundant in the earth's crust and have been drawing attention as economical and environmentally friendly materials due to their non-toxicity.

However, it has been studied to introduce a protection layer and a thin film layer to remedy the poor operating stability due to corrosion and poor surface characteristics of the metal oxide-based materials.

Representatively, protection layers and thin film layers based on metal sulfides, metal nitrides, metal phosphides, and metal hydroxides are used to alleviate the corrosion of the metal oxide-based substrate and promote the behavior of charge carriers.

There are various deposition techniques such as photo/electrodeposition, chemical vapor deposition, atomic layer deposition, and spray coating as a method for introducing such protection layers and thin film layers.

However, these conventional technologies may inevitably have the problem of generating byproducts that are toxic to the human body or harmful to the environment.

In addition, the energy consumption required in a synthesis process is large, which reduces economic feasibility.

Therefore, there is a need for the development of a technology that can control the electronic structure at the atomic level to improve the surface properties and stability of optical and electrical materials, control the shape, and induce a protection layer and thin film layer at the nanometer level that are practically environmentally friendly and harmless during the implementation process.

### SUMMARY

An aspect of the disclosure is to control the characteristics of a substrate including a metal oxide by introducing a thin film-type protection layer on which a natural molecule-derived organic material-metal complex is uniformly deposited.

To achieve the aspect, an embodiment of the disclosure provides a photoelectrode into which an organic-metal composite thin film is uniformly introduced.

The organic-metal composite thin film photoelectrode according to an embodiment of the disclosure may include: a substrate; a photoelectrode layer positioned on the substrate and composed of a semiconducting metal compound; and a protection layer positioned on the photoelectrode layer and including a natural molecule-derived organic material-metal complex uniformly deposited thereon, wherein the photoelectrode layer and the protection layer are chemically bonded.

In addition, according to an embodiment of the disclosure, the semiconductor metal compound may include a metal oxide, a metal nitride, a metal carbide or a metal sulfide.

In addition, according to an embodiment of the disclosure, the metal oxide may include WO₃, TiO₂, Fe₂O₃ or BiVO₄.

In addition, according to an embodiment of the disclosure, the metal nitride may include Ta₃N₅, GaN or InN.

In addition, according to an embodiment of the disclosure, the metal carbide may include Ti₃C₂, Mo₂C or W₂C.

In addition, according to an embodiment of the disclosure, the metal sulfide may include ZnS, MoS₂, CuS or CdS.

In addition, according to an embodiment of the disclosure, the natural molecule-derived organic material-metal complex may be a nanostructure in which the natural molecule-derived organic material and a metal positive ion are self-assembled through coordination bonding.

In addition, according to an embodiment of the disclosure, the natural molecule-derived organic material may include quercetin, epigallocatechin gallate, alliin or curcumin.

In addition, according to an embodiment of the disclosure, the metal may include nickel (Ni), cobalt (Co), iron (Fe) or zinc (Zn).

In addition, according to an embodiment of the disclosure, the thickness of the protection layer may be several nm.

To achieve the aspect, another embodiment of the disclosure provides a method for producing an organic-metal composite thin film photoelectrode.

The method for producing an organic-metal composite thin film photoelectrode according to an embodiment of the disclosure may include: depositing a photoelectrode layer by performing a sol-gel scheme on a substrate; and uniformly applying a natural molecule-derived organic material-metal complex on the photoelectrode layer to form a protection layer.

In addition, according to an embodiment of the disclosure, in the depositing of the photoelectrode layer, the photoelectrode layer may include a metal oxide, a metal nitride, a metal carbide or a metal sulfide.

In addition, according to an embodiment of the disclosure, in the depositing of the photoelectrode layer, the metal oxide may include WO₃, TiO₂, Fe₂O₃ or BiVO₄.

In addition, according to an embodiment of the disclosure, in the depositing of the photoelectrode layer, the metal nitride may include Ta₃N₅, GaN or InN.

In addition, according to an embodiment of the disclosure, in the depositing of the photoelectrode layer, the metal carbide may include Ti₃C₂, Mo₂C or W₂C.

In addition, according to an embodiment of the disclosure, in the depositing of the photoelectrode layer, the metal sulfide may include ZnS, MoS₂, CuS or CdS.

In addition, according to an embodiment of the disclosure, in the forming of the protection layer,

A solution containing the natural molecule-derived organic material-metal complex may be dropped onto the photoelectrode layer and then dried for a preset time.

In addition, according to an embodiment of the disclosure, the natural molecule-derived organic material may include quercetin, epigallocatechin gallate, alliin or curcumin.

In addition, according to an embodiment of the disclosure, the metal may include nickel (Ni), cobalt (Co), iron (Fe) or zinc (Zn).

In addition, according to an embodiment of the disclosure, the thickness of the protection layer may be several nm.

An organic-metal composite thin film photoelectrode according to an embodiment of the disclosure has an effect of providing an active site suitable for a water oxidation reaction through a controlled organic material functional group-positive metal ion interaction, thereby exhibiting improved surface catalytic activity and high light absorption efficiency.

In addition, an organic-metal composite thin film photoelectrode according to an embodiment of the disclosure has an effect of significantly improving the device operation stability and charge behavior as a thin film of several nanometers in thickness by forming a strong bond by aligning an organic material-metal complex on a photoelectrode layer and forming a chemical interaction.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a composite device composed of a natural molecule-derived organic material-metal complex and a photoelectrode, and a schematic diagram for improving the photoelectrochemical characteristics;

FIG. 2 is a view showing the chemical structure of quercetin;

FIG. 3 is a graph showing the functional group analysis of a quercetin and quercetin-nickel complex (QNi);

FIGS. 4A, 4B, 4C, 4D, 4E, and 4F are each a high-magnification image for observing the nanomorphology of a WO₃ electrode (QNi/WO₃) to which a quercetin-nickel complex (QNi) thin film was introduced;

FIGS. 5A, 5B, and 5C are each a high-magnification image of QNi/WO₃ for confirming nickel existing only in a quercetin-nickel complex (QNi) thin film;

FIGS. 6A, 6B, and 6C are each a graph and image showing the preparing conditions of the comparative example (CNi/WO₃) and the results of observing the crystallinity after preparing;

FIGS. 7A, 7B, 7C, 7D, and 7E are each a graph showing the analysis of a bonding state between elements on an electrode surface before and after the introduction of an organic material-metal complex thin film;

FIGS. 8A, 8B, and 8C are each a graph showing the analysis of optical and optoelectronic characteristics according to the introduction of an organic material-metal complex thin film;

FIGS. 9A and 9B are each a graph showing the analysis of photoelectrochemical and electrochemical charge behaviors for WO₃, QNi/WO₃, and CNi/WO₃;

FIGS. 10A, 10B, 10C, 10D, 10E, and 10F are each an image and graph showing the analysis of the stability of QNi/WO₃ after the photoelectrochemical water oxidation operation;

FIGS. 11A, 11B, 11C, and 11D are each a graph showing the electrochemical active surface area analysis for WO₃, QNi/WO₃, and CNi/WO₃ electrodes; and

FIGS. 12A, 12B, and 12C are each a graph showing the performance analysis for a photoelectrochemical water electrolysis reaction under light irradiation conditions of WO₃, QNi/WO₃, and CNi/WO₃.

### DETAILED DESCRIPTION

Hereinafter, preferred embodiments of the disclosure, which may specifically achieve the aspects as described above, are described with reference to the accompanying drawings. In describing these embodiments, the same names and symbols may be used for the same components, and additional descriptions thereof may be omitted.

As a photoelectrode material, metal oxide-based semiconductor materials are abundant in the earth's crust and have been attracting attention as economical and environmentally friendly materials due to their non-toxicity, but they have a problem of poor operating stability due to corrosion. In order to solve this surface corrosion problem, protection layers based on metal sulfides, metal nitrides, metal phosphides, and metal hydroxides have been used conventionally. However, these protection layers may have problems of generating byproducts that are toxic to the human body or harmful to the environment. Accordingly, the disclosure provides an organic-metal composite thin film photoelectrode including a protection layer on which a natural molecule-derived organic material-metal complex is uniformly deposited.

Hereinafter, the disclosure will be described with reference to the drawings presented in this specification. For reference, the drawings may be expressed in an exaggerated manner to explain the features of the disclosure. In this case, it is preferable to interpret them in light of the entire intent of the present specification.

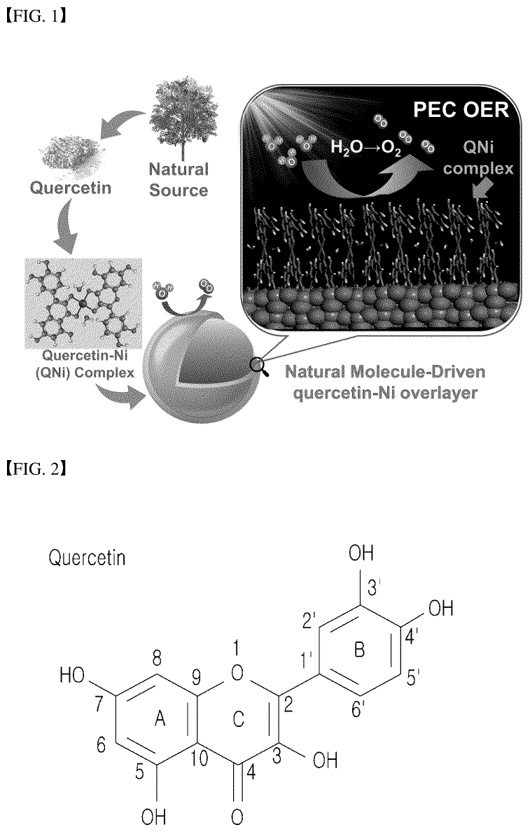

An organic-metal composite thin film-coated photoelectrode according to an embodiment of the disclosure will be described with reference to FIGS. 1 and 2.

FIG. 1 is a schematic diagram of a natural molecule-derived organic material-metal complex and an organic-metal composite thin film-coated photoelectrode, and a schematic diagram for improving the photoelectrochemical properties.

FIG. 2 is a view showing the chemical structure of quercetin.

Referring to FIGS. 1 and 2, an organic-metal composite thin film-coated photoelectrode may include: a substrate; a photoelectrode layer positioned on the substrate and composed of a semiconducting metal compound; and a protection layer positioned on the photoelectrode layer and including a natural molecule-derived organic material-metal complex uniformly deposited thereon.

At this time, the photoelectrode layer and the protection layer may be chemically bonded.

The disclosure may include a substrate.

At this time, for example, the substrate may use an FTO substrate, but is not limited to the above-described example, and any one having electrical conductivity may be used without limitation.

In addition, the disclosure may include a photoelectrode layer.

At this time, the photoelectrode layer is positioned on the substrate and composed of a semiconducting metal compound.

At this time, the semiconducting metal compound may include a metal oxide, a metal nitride, or a metal carbide.

At this time, the metal oxide used in the disclosure may include WO₃, TiO₂, Fe₂O₃ or BiVO₄.

In addition, the metal nitride used in the disclosure may include Ta₃N₅, GaN or InN.

In addition, the metal carbide used in the disclosure may include Ti₃C₂, Mo₂C or W₂C.

In addition, the metal sulfide used in the disclosure may include ZnS, MoS₂, CuS or CdS.

In addition, the disclosure may include a protection layer.

At this time, the protection layer is positioned on the photoelectrode layer, and a natural molecule-derived organic material-metal complex is uniformly deposited.

At this time, the protection layer is coated on the upper part of the photoelectrode layer composed of a semiconducting metal compound, so as to prevent the poor operating stability due to corrosion of the conventional photoelectrode and improve the optical and electrical characteristics.

In addition, when the organic material-metal complex is introduced as a thin film, a self-assembling structure is formed through the coordination bond between a functional group at the end of the organic material and a positive metal ion, so that the positive metal ion may be stabilized and an active site may be provided where a reactant is easily adsorbable and activatable.

In particular, the organic material-metal complex of the disclosure has an effect of controlling the electronic structure at the atomic level and performing shape control by controlling the combination of a metal and a functional group of the organic material.

At this time, the natural molecule-derived organic material-metal complex as the protection layer includes a natural molecule-derived organic material.

The natural molecule-derived organic material-metal complex of the disclosure may be a nanostructure in which the natural molecule-derived organic material and the metal are self-assembled through coordination bonding.

At this time, the natural molecule-derived organic material may include quercetin, epigallocatechin gallate, alliin, or curcumin.

At this time, as the natural molecule-derived organic material, any one having a characteristic of being a chelating ligand capable of forming a complex ion with a positive metal ion may be used without limitation without being limited to the above-described example.

At this time, the quercetin is a secondary metabolite widely known as a flavonoid substance known as polyphenol. This is widely distributed in nature and is contained in various fruits and vegetables that are most accessible, such as mangoes, apples, and plums, and is especially abundant in onions.

In addition, the quercetin has many functional groups that include oxygen in the chemical structure thereof to be able to form a self-assembly complex by stabilizing a positive metal ion such as nickel through coordination bonding.

At this time, referring to FIG. 2, it is possible to confirm that the quercetin may maintain a two-dimensional planar structure and has oxygen-based functional groups.

In addition, since the quercetin has many sp2 orbitals, the abundant electrons of the quercetin may have coordination bonding with a positive metal ion.

In addition, the metal may include nickel (Ni), cobalt (Co), iron (Fe), or zinc (Zn), and any one having a characteristic capable of forming coordination bonding with a chelating ligand may be used without being limited to the example described above.

In addition, the protection layer of the disclosure is uniformly deposited on the photoelectrode layer. At this time, the disclosure may drop a solution containing a natural molecule-derived organic material-metal complex on the photoelectrode layer, and then dry the solution so that the solvent evaporates to form a uniform thin film.

Referring to FIG. 2, quercetin, which constitutes the organic material-metal complex of the protection layer of the disclosure, has a number of functional groups containing oxygen in the chemical structure thereof, and may stabilize a positive metal ion such as nickel through coordination bonding and form a self-assembling complex.

At this time, the thickness of the protection layer may be several nm without being set.

At this time, the reason why the thickness of the protection layer is several nm is that if the thickness of the thin film is too thin, there may be a problem of not securing sufficient stability or not being able to exhibit effective property improvement, and if the thickness exceeds several nm, there may be a problem of deterioration of electrical conductivity and charge dynamics.

In addition, the organic-metal composite thin film photoelectrode of the disclosure is characterized in that the photoelectrode layer and an organic material-metal complex protection layer are chemically bonded.

At this time, the photoelectrode layer and the protection layer are chemically bonded to improve the electrical behavior within the device, thereby effectively transferring photogenerated charges in the photoelectrode layer to metal active sites within the protection layer, thereby inducing improved photoelectrical performance and high surface catalytic activity.

Therefore, the natural molecule-derived organic material-metal complex is derived from natural molecules and has environmentally friendly characteristics, the protection layer functions as to improve light absorption efficiency, enhance the photoelectron migration efficiency, improve the electrical characteristics, the interaction within the natural molecule-derived organic material-metal complex provides an active site suitable for water oxidation reaction, thereby securing improved charge transfer kinetics, and the shape aligned by the electronic structure within the natural molecule-derived organic material-metal complex forms a strong bond with a metal oxide surface, thereby greatly improving the device operating stability.

The thin film forming technology of the disclosure may perform various combinations between the types of organic materials, the functional groups of an organic material, and a metal in a natural molecule-derived organic material-metal complex, and may improve the optical absorbance, electronic structure, charge dynamics at the interface, and operating stability of a substrate material, so as to be applicable to various fields to improve the material properties and stability.

A method for preparing an organic-metal composite thin film photoelectrode according to another embodiment of the disclosure will be described.

A method for preparing an organic-metal complex thin film photoelectrode according to an embodiment of the disclosure may include: depositing a photoelectrode layer by performing a sol-gel method on a substrate; and uniformly applying a natural molecule-derived organic material-metal complex on the photoelectrode layer to form a protection layer.

A first step may include depositing a photoelectrode layer by performing a sol-gel method on a substrate.

In the disclosure, as the substrate, an FTO substrate may be used, but any one having electrical conductivity may be used without limitation without being limited to the above-described example.

At this time, the photoelectrode layer may include a metal oxide, a metal nitride, a metal carbide, or a metal sulfide.

At this time, the metal oxide used in the disclosure may include WO₃, TiO₂, Fe₂O₃ or BiVO₄.

In addition, the metal nitride used in the disclosure may include Ta₃N₅, GaN or InN.

In addition, the metal carbide used in the disclosure may include Ti₃C₂, Mo₂C or W₂C.

In addition, the metal sulfide used in the disclosure may include ZnS, MoS₂, CuS or CdS.

At this time, in the depositing of the photoelectrode layer, a base material WO₃ may be, for example, synthesized using a sol-gel method, and specifically, the depositing of the photoelectrode layer may include: preparing a tungsten precursor solution by adding polyethylene glycol-300 to a mixed solution of 9 g of tungsten powder, 10 mL of hydrogen peroxide, and 25 mL of 2-propanol; and dropping 20 μL of the tungsten precursor solution onto an FTO substrate having a size of 1.5 cm×2 cm, drying the same at room temperature, and then heat-treating the same in an electric furnace at 550° C. for 2 hours to form WO₃.

A second step may include uniformly applying a natural molecule-derived organic material-metal complex on the photoelectrode layer to form a protection layer.

In this step, a solution containing the natural molecule-derived organic material-metal complex is dropped onto a metal oxide layer and then dried for a preset time.

At this time, the preset time may be 30 minutes to 1 hour, and may vary depending on the volume of a solvent in the solution containing the natural molecule-derived organic material-metal complex, and the drying may be performed so that the solvent evaporates.

At this time, the natural molecule-derived organic material may include quercetin, epigallocatechin gallate, alliin, or curcumin.

In addition, the metal may include nickel (Ni), cobalt (Co), iron (Fe), or zinc (Zn), and any one having a characteristic capable of forming coordination bonding with a chelating ligand may be used without being limited to the example described above.

For example, the quercetin-nickel complex (QNi) of the disclosure may be produced by dissolving quercetin and nickel chloride in 20 mL of methanol, adjusting the pH to 10 using a 0.5 M sodium hydroxide-methanol solution, and then stirring the same at room temperature for 2 hours.

In addition, regarding preparation of a substrate (QNi/WO₃) containing tungsten trioxide on which a quercetin-nickel complex is deposited, 150 μL of a QNi solution is dropped on tungsten trioxide (WO₃) and dried for 30 minutes to allow a solvent to evaporate to form a uniform thin film, and then, to remove residues, the solution is washed with deionized water (DI water) and dried with nitrogen so that QNi/WO₃ is synthesized.

At this time, the thickness of the protection layer may be several nm without being set.

At this time, the reason why the thickness of the protection layer is several nm is that if the thickness of the thin film is too thin, there may be a problem of not securing sufficient stability or not being able to exhibit effective property improvement, and if the thickness exceeds several nm, there may be a problem of deterioration of electrical conductivity and charge behaviors.

Therefore, it is possible to confirm that a photoelectrode in which a quercetin-nickel complex (QNi) thin film is uniformly introduced on the surface of a tungsten trioxide layer (WO₃) with a thickness of 2 nm and which was produced through the method for producing an organic-metal composite thin film photoelectrode of the disclosure has various improved physical properties such as enhanced light absorption efficiency, enhanced photoelectron migration, improved electrical characteristics, enhanced aqueous stability, and expanded surface active sites.

For example, efficient oxygen evolution was shown with excellent photoelectrocatalytic characteristics, and it is possible to show stable response current even during 15 hours of operation, and detailed proof will be described later in Experimental Examples below.

In addition, through the analysis of optical and electrical characteristics, it may be suggested that a QNi thin film layer is capable of efficiently transferring photogenerated charges to a chemical reaction through effective light absorption, and a thin film containing an organic material-metal complex may protect a photoelectrode layer surface from photocorrosion and surface collapse while improving the electrical behavior within an electrode, thereby effectively transferring the photogenerated charges in the photoelectrode layer to a nickel active site in the thin film, thereby inducing high surface catalytic activity.

Accordingly, a QNi thin film layer may dramatically improve the activity and stability of an electrode as a cocatalyst and protection layer.

Therefore, the technology presented in the disclosure forms a non-toxic organic material-metal complex based on natural materials based on an understanding of the interaction between organic material functional groups and metal positive ions, and a uniform thin film layer of several nanometers introduced therethrough has an effect of improving the material properties and stability by an electronic structure in an organic material-metal complex, and greatly improving the performance and operating stability of the device.

Hereinafter, the disclosure will be described in more detail through Producing Examples and Experimental Examples. These Producing Examples and Experimental Examples are only intended to exemplify the disclosure, and the scope of the disclosure is not limited by these Producing Examples and Experimental Examples.

### Producing Example: Organic-Metal Composite Thin Film Photoelectrode (QNi/WO₃) Preparation

WO₃ may be synthesized by a sol-gel method.

First, as a detailed description, a tungsten precursor solution was prepared by adding polyethylene glycol-300 to a mixed solution of 9 g of tungsten powder, 10 mL of hydrogen peroxide, and 25 mL of 2-propanol.

Next, 20 μL of the tungsten precursor solution was dropped onto a 1.5 cm×2 cm FTO substrate, dried at room temperature, and heat-treated in an electric furnace at 550° C. for 2 hours to synthesize tungsten trioxide (WO₃).

Next, a quercetin-nickel complex (QNi) was prepared by dissolving quercetin and nickel chloride in 20 mL of methanol, adjusting the pH to 10 using a 0.5 M sodium hydroxide-methanol solution, and stirring the same at room temperature for 2 hours.

Next, to produce QNi/WO₃, 150 μL of a QNi solution was dropped onto WO₃ and dried for 30 minutes to allow a solvent to evaporate to form a uniform thin film.

Next, to remove residues, the solution was washed with deionized water (DI water) and dried with nitrogen to synthesize an organic-metal composite thin film photoelectrode (QNi/WO₃).

QNi/WO₃ refers to an organic-metal composite thin film photoelectrode in which a quercetin-nickel complex (QNi) is deposited on a substrate coated with WO₃.

### Comparative Example: Carbonized Organic-Metal Composite Thin Film Photoelectrode (C-Ni/WO₃)

The complex photoelectrode (QNi/WO₃) prepared by the above Producing Example was carbonized at 500° C. for 2 hours to synthesize a carbonized organic-metal composite thin film photoelectrode (C-Ni/WO₃).

### Experimental Example 1: Quercetin-Nickel Complex (QNi) Synthesis Analysis

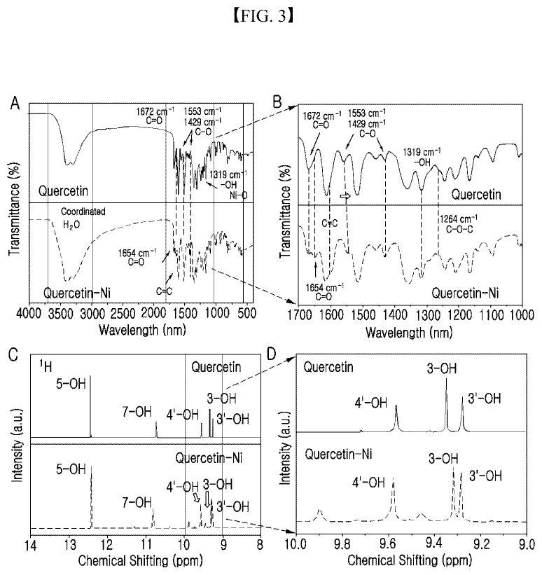

FIG. 3 is a graph showing the functional group analysis of quercetin and a quercetin-nickel complex.

A and B of FIG. 3 are each a graph observing a change in a quercetin functional group according to complex formation through FT-IR, and C and D of FIG. 3 are each a graph observing a change in a quercetin functional group according to complex formation through 1H-NMR.

In this Experimental Example 1, a molecular structure was analyzed and a coordination site was specified through Fourier transform-infrared spectroscopy (FT-IR) analysis and proton nuclear magnetic resonance (1H-NMR) analysis on quercetin and a quercetin-nickel complex.

Referring to FIG. 3, it was confirmed that a carbonyl group (C═O) and hydroxyl group exist among oxygen functional groups abundant in quercetin.

In addition, the Ni—O vibration was confirmed to confirm that an organic metal complex was well formed.

In addition, it was clarified that nickel may exist in the form of a metal rather than an ion due to the change of 3-OH in quercetin.

### Experimental Example 2: QNi/WO₃ Nanomorphology and Structure Analysis

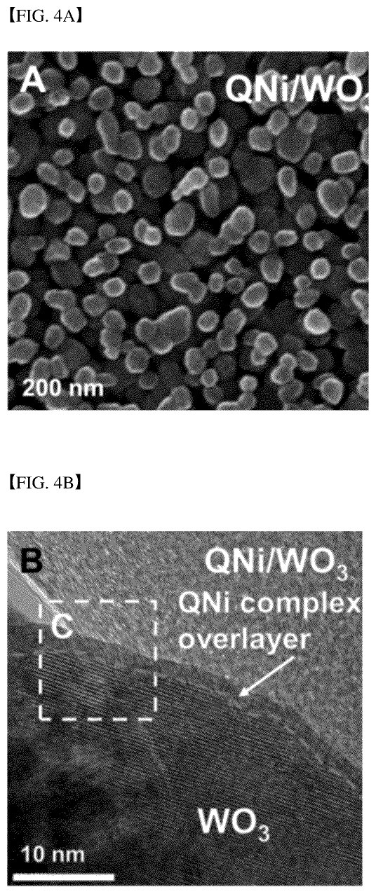

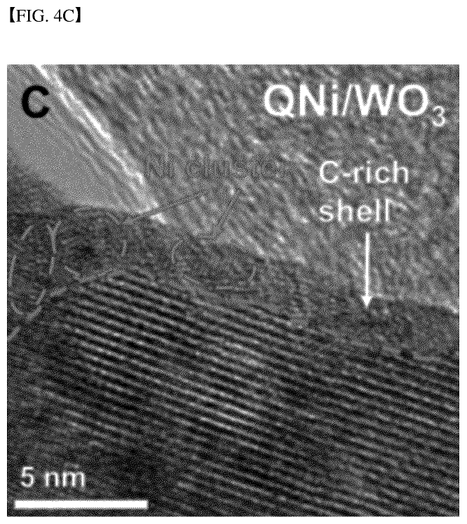

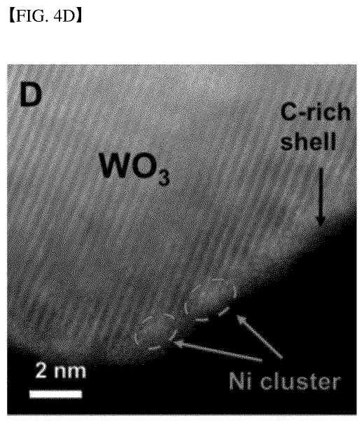

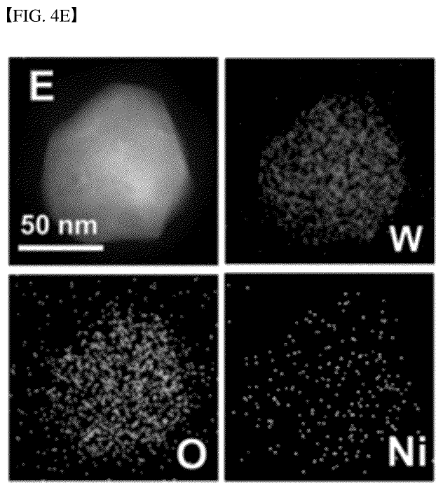

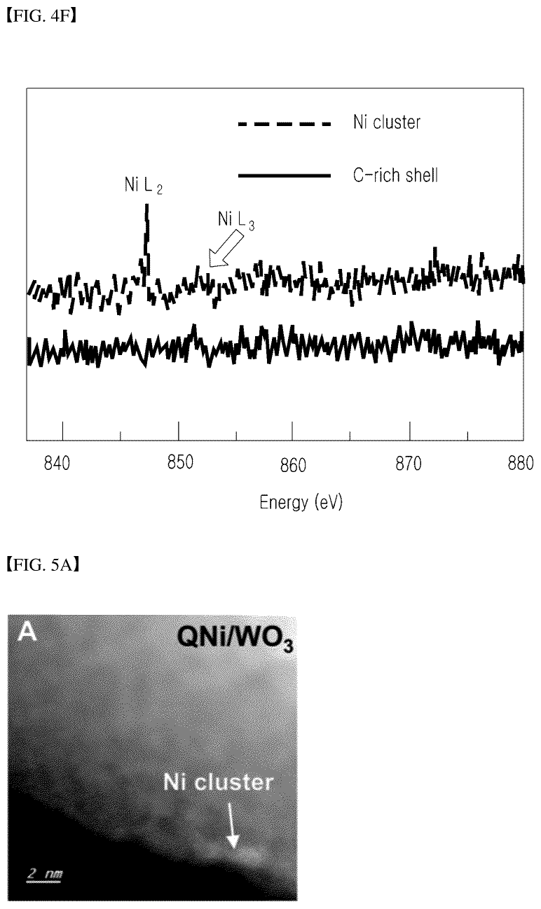

FIGS. 4A, 4B, 4C, 4D, 4E, and 4F are each a high-magnification image for observing the nanomorphology of a WO₃ electrode to which a quercetin-nickel complex (QNi) thin film is introduced.

FIG. 4A is an SEM image of QNi/WO₃ electrode, FIGS. 4B and 4C are each an HR-TEM image, FIG. 4D is an HADDF-STEM image, FIG. 4E is elemental distribution measurement using EDS, and FIG. 4F is an EELS element spectrum.

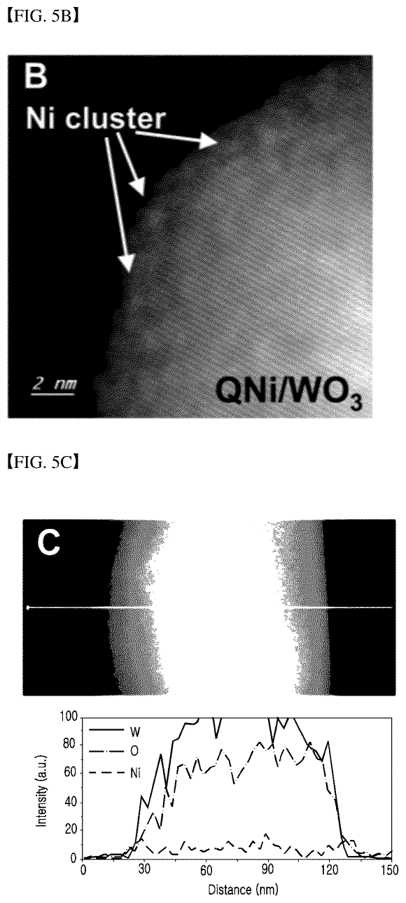

FIGS. 5A, 5B, and 5C are each a high-magnification image of QNi/WO₃ for confirming nickel existing only in a quercetin-nickel complex (QNi) thin film.

FIGS. 5A and 5B are each an HADDF-STEM image of a QNi/WO₃ electrode, and FIG. 5C is an HADDF-STEM image of a QNi/WO₃ electrode and an image measuring the elemental distribution using EDS line scan.

In this Experimental Example 2, in order to observe nano-level morphological changes of QNi/WO₃, an electrode surface is analyzed by field emission scanning electron microscope (FESEM), high resolution-transmission electron microscope (HR-TEM), high-angle annular dark-field scanning transmission electron microscopy (HADDF-STEM), and energy dispersive spectroscopy elemental mapping (EDS elemental mapping).

Referring to FIGS. 4A, 4B, 4C, 4D, 4E, and 4F, a mesoporous structure composed of 50 nm-sized spheres was observed.

In addition, a QNi thin film was uniformly coated on a WO₃ surface with a thickness of about 2 nm, and it was possible to observe the morphology of a crystalline nickel-based cluster covered by a low-crystalline carbon-based shell.

In addition, referring to FIGS. 5A, 5B, and 5C, it is possible to confirm that nickel exists only on the surface layer of the thin film.

### Experimental Example 3: Comparative Example CNi/WO₃ Nanomorphology and Structure Analysis

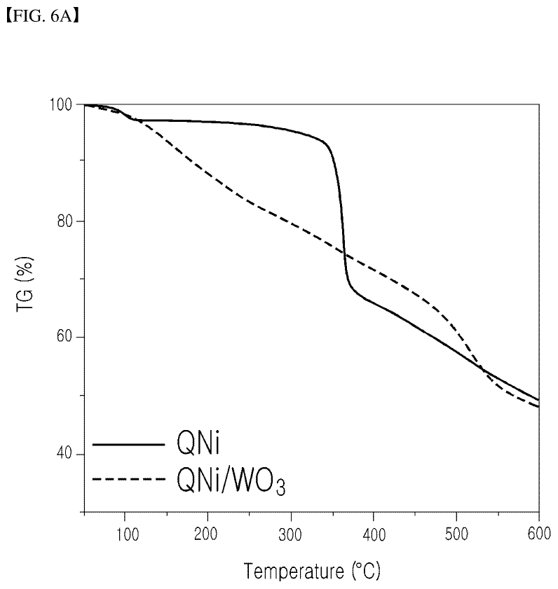

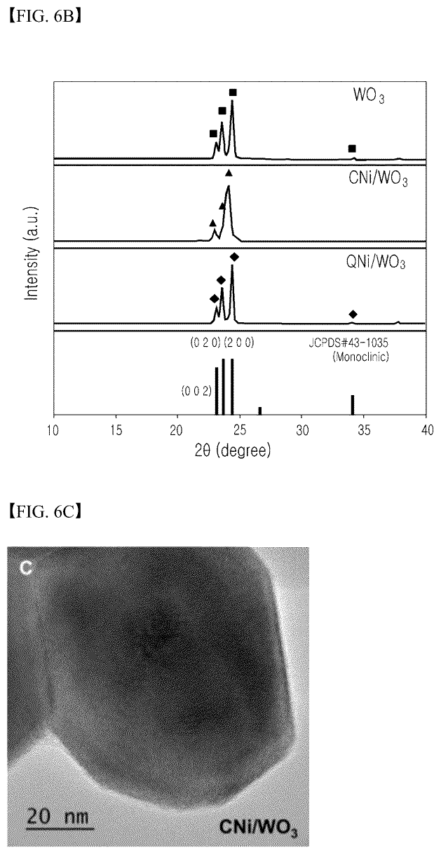

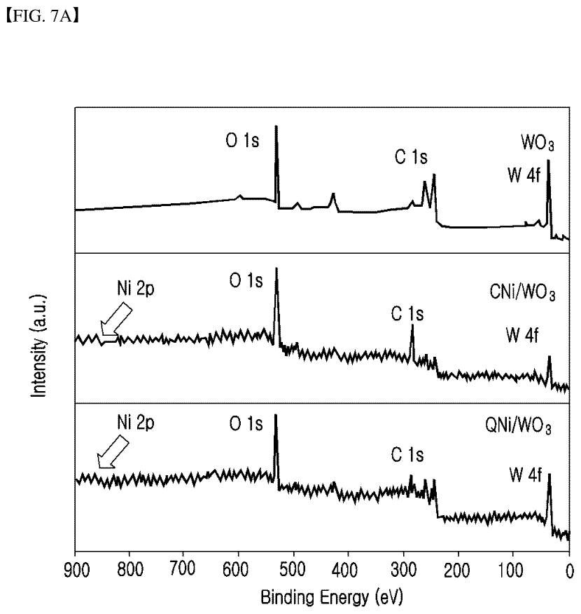

FIGS. 6A, 6B, and 6C are each a graph and an image showing the results of preparation for Comparative Example CNi/WO₃.

This Experimental Example 3 is a comparative group of QNi/WO₃, and the crystallinity and nano-level shape of carbonized CNi/WO₃ were analyzed.

FIG. 6A is a thermogravimetric analysis (TGA) performed on QNi and QNi/WO₃ to set the carbonization temperature.

FIG. 6B is X-ray diffraction (XRD) patterns for WO₃, QNi/WO₃, and CNi/WO₃, and FIG. 6C is HR-TEM image of CNi/WO₃.

Referring to FIGS. 6A, 6B, and 6C, it was confirmed that the carbonization of QNi occurred at approximately 400° C., but when introduced to WO₃ as a thin film, carbonization occurred at approximately 500° C., so that the temperature for producing CNi/WO₃ was set to 500° C.

The shape of the CNi/WO₃ produced through this process was observed to have a thinner amorphous thin film layer formed on a substrate surface.

In addition, X-ray diffraction analysis was performed to analyze the crystallinity of WO₃, CNi/WO₃, and QNi/WO₃, and it was confirmed that the crystal structure of the substrate was maintained as monoclinic even when a thin film was formed, wherein it is possible to confirm that the crystallinity is not significantly affected thereby.

### Experimental Example 4: Chemical Bonding and Structure Analysis According to Introduction of Organic Material-Metal Complex Thin Film Layer

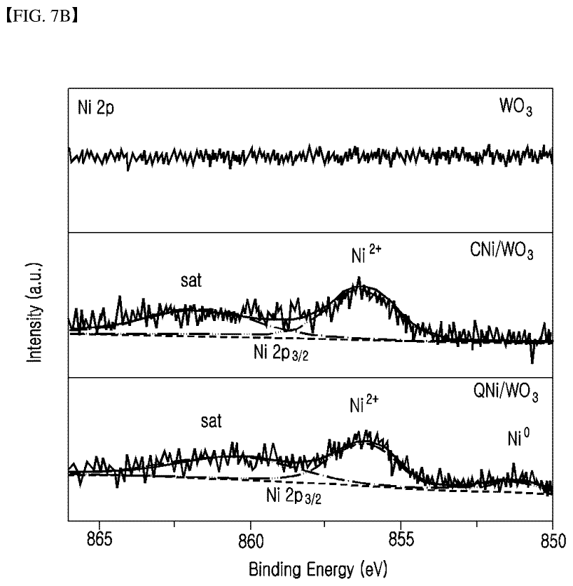

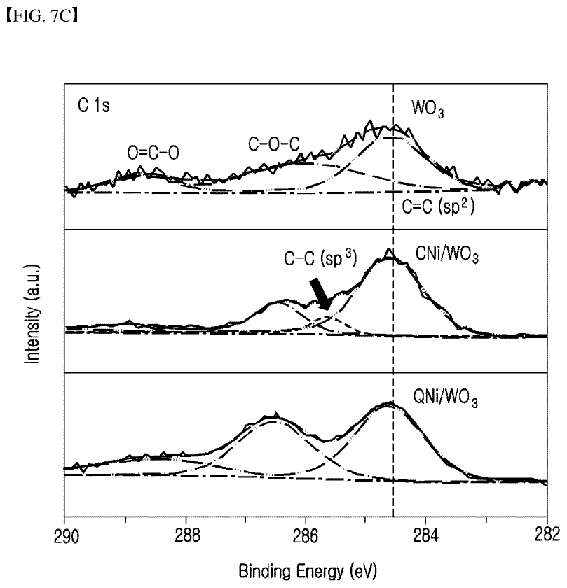

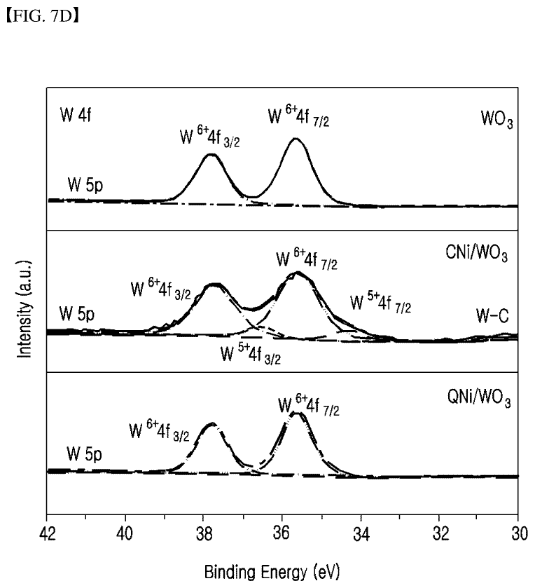

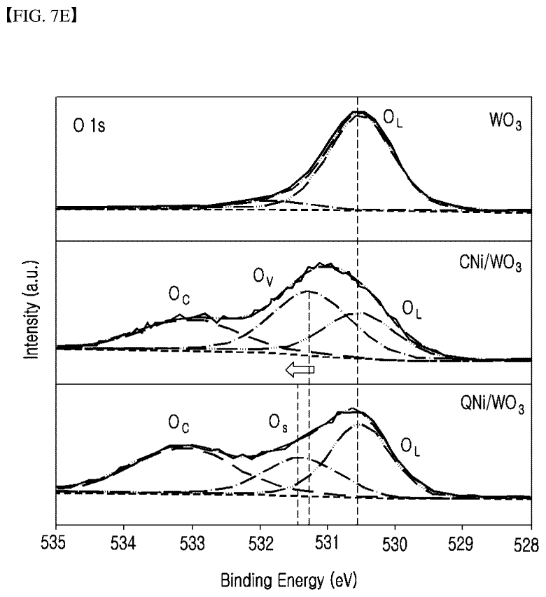

FIGS. 7A, 7B, 7C, 7D, and 7E are each a graph showing the analysis of a chemical states for the elements on an electrode surface before and after the introduction of an organic material-metal complex thin film and further carbonization.

FIGS. 7A, 7B, 7C, 7D, and 7E are each an XPS Survey spectrum (7A) and a high-resolution XPS spectrum, which is for (7B) Ni 2p, (7C) C 1s, (7D) W 4f, or (7E) O 1s, of a WO₃ electrode before and after the introduction of QNi and CNi.

In this Experimental Example 4, X-ray photoelectron spectroscopy (XPS) was performed on QNi/WO₃ and CNi/WO₃ to compare and analyze the chemical bonding changes for the elements on the surface of photoelectrode, including WO₃.

Referring to FIGS. 7A, 7B, 7C, 7D, and 7E, it was confirmed that quercetin exists stably through a strong C—O—C bond of QNi/WO₃, and that carbonization was successfully performed through a newly appeared C—C bond in CNi/WO₃.

In addition, it was confirmed that there was an intermolecular interaction in a W 4f spectrum of QNi/WO₃.

On the other hand, in the case of CNi/WO₃, a W⁵⁺ peak appeared, which means that oxygen defects were induced by tungsten carbide.

In particular, it is possible to confirm that a Ni⁰ peak, which indicates metallic nickel, was confirmed only in QNi/WO₃ in an Ni 2p spectrum.

Through this, it is possible to confirm that tungsten in the form of a metal oxide is not affected thereby even after the formation of an organic metal composite thin film.

On the other hand, in the case of the quercetin-nickel (QNi) complex, this generally exists as an oxidized form of Ni²⁺, and the chemical structure of a QNi complex may be identified.

### Experimental Example 5: Analysis of Optical and Optoelectronic Properties Before and After Introduction of Organic Material-Metal Complex Thin Film Layer

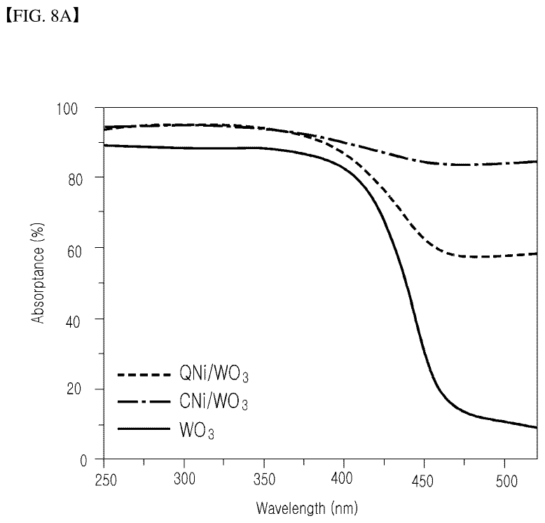

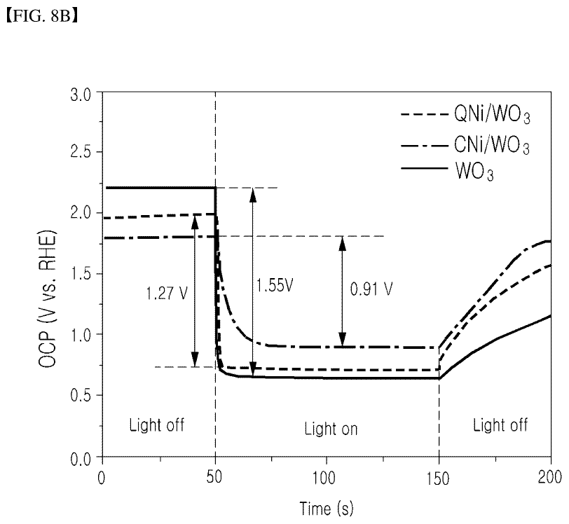

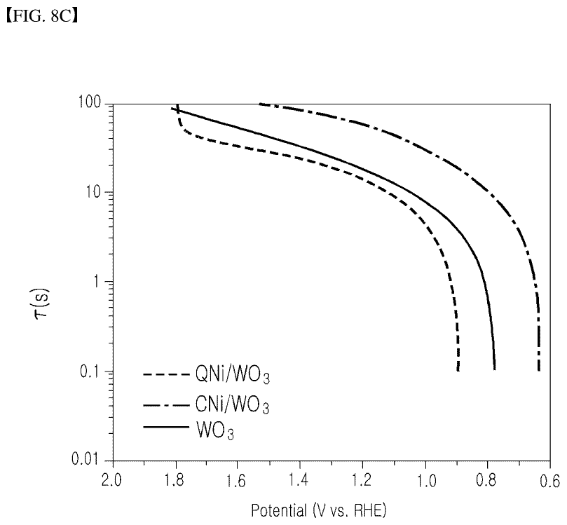

FIGS. 8A, 8B, and 8C are each a graph showing the analysis of optical and optoelectronic characteristics according to the introduction of an organic material-metal complex thin film.

FIG. 8A shows the analysis of light absorption efficiency through UV-visible spectroscopy of WO₃, QNi/WO₃, and CNi/WO₃. FIG. 8B is the open circuit voltage analysis according to the presence or absence of sunlight irradiation, and FIG. 8C is the photocharge lifetime analysis.

This Experimental Example 5 analyzed light absorption efficiency through UV-Visible spectroscopy to observe optical characteristic changes of the produced WO₃, CNi/WO₃, and QNi/WO₃.

Referring to FIGS. 8A, 8B, and 8C, it is possible to confirm that a material with an organic material-metal complex thin film layer introduced thereto exhibits improved light absorption efficiency compared to the existing substrate.

In addition, through the open circuit potential (OCP) analysis according to the presence or absence of light irradiation and the photocharge lifetime analysis therethrough, it is possible to confirm that CNi/WO₃ shows a long photocharge lifetime due to the trapped photocharge that does not move to a circuit compared to a substrate WO₃, while QNi/WO₃ shows excellent optoelectronic characteristics in which the photocharge moves to a circuit quickly.

### Experimental Example 6: Analysis of Electrical Characteristics and Stability Before and After Introduction of Organic Material-Metal Complex Thin Film Layer

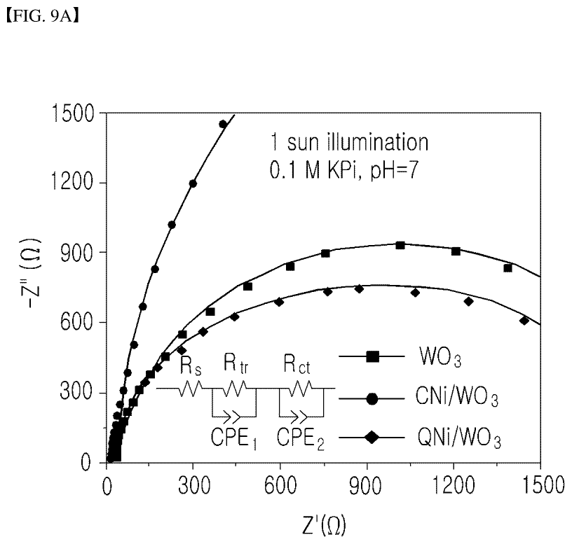

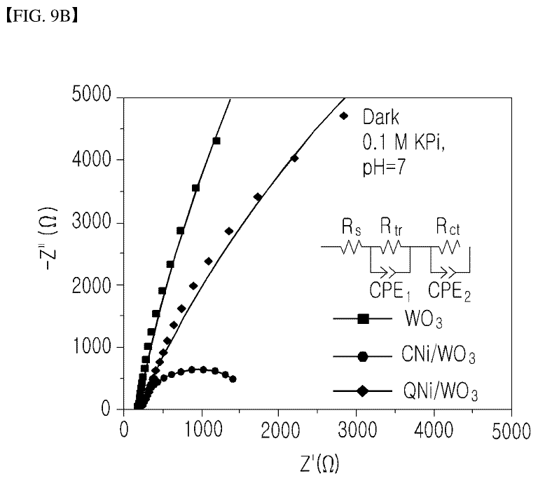

FIGS. 9A and 9B are graphs showing the photo-/electrochemical impedance analysis for WO₃, QNi/WO₃, and CNi/WO₃.

FIG. 9A is the electrochemical impedance analysis under light irradiation conditions. FIG. 9B is the electrochemical impedance analysis under dark conditions.

In this Experimental Example 6, the charge behavior analysis for WO₃, CNi/WO₃, and QNi/WO₃ was performed by electrochemical impedance spectroscopy (EIS).

Referring to FIGS. 9A and 9B, it is possible to confirm that all specimens with organic material-metal complex thin films introduced thereto show improved electrochemical properties under dark conditions.

In particular, QNi/WO₃ showed excellent electrical properties compared to WO₃ through efficient charge behaviors under light irradiation conditions, whereas CNi/WO₃ showed poor properties compared to WO₃ under light irradiation conditions.

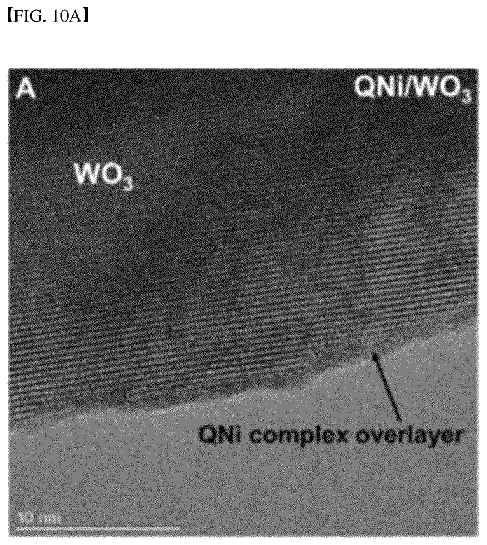

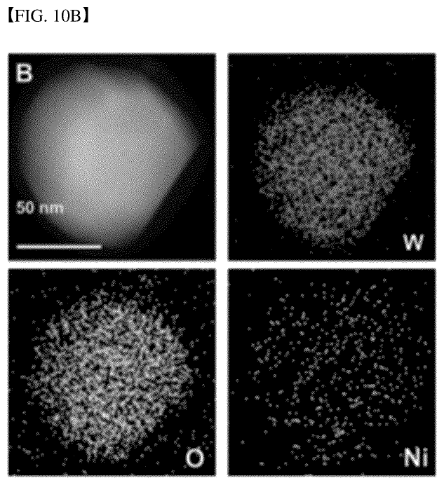

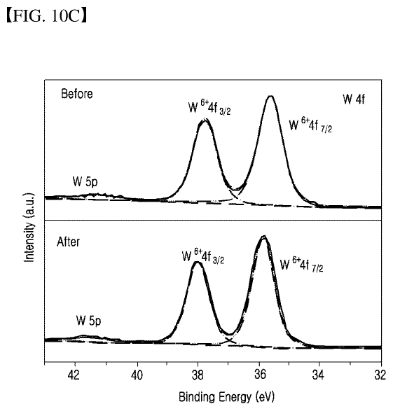

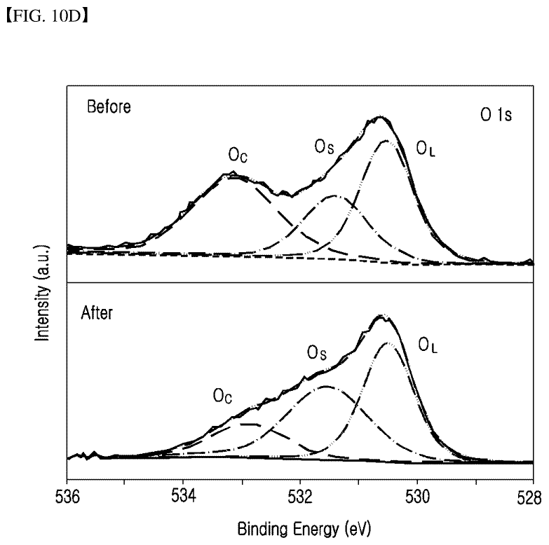

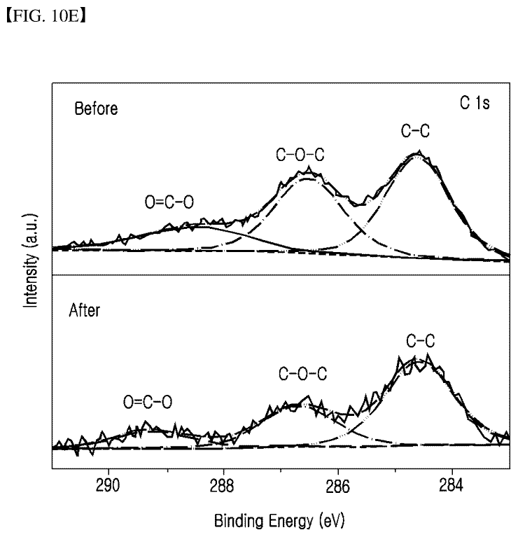

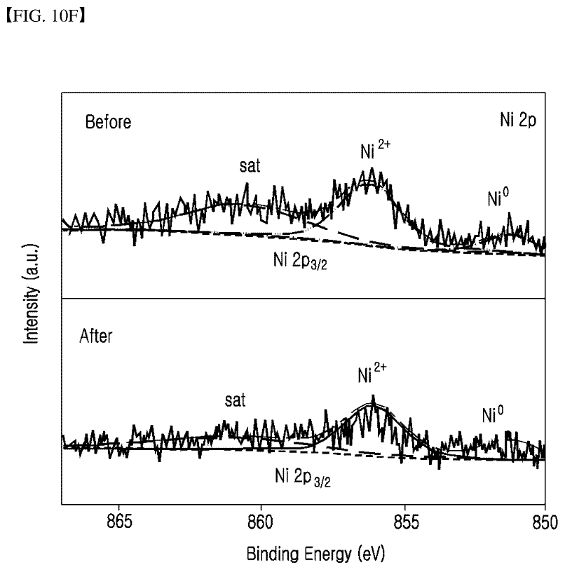

FIGS. 10A, 10B, 10C, 10D, 10E, and 10F are each an image and graph showing the analysis of the stability of QNi/WO₃ after the photoelectrochemical water oxidation operation.

FIGS. 10A, 10B, 10C, 10D, 10E, and 10F are each an HR-TEM image (10A) of QNi/WO₃ after the operation, (10B) the elemental distribution through EDS analysis, and a high-resolution XPS spectrum for (10C) W 4f, (10D) O 1s, (10E) C 1s, or (10F) Ni 2p before and after the photoelectrochemical water oxidation reaction.

In FIG. 10, the stability of the organic material-metal complex thin film after applying a voltage in an aqueous electrolyte for QNi/WO₃ was analyzed through the HR-TEM and XPS analysis.

Referring to FIG. 10, both the QNi organic metal composite thin film and the WO₃ substrate are stably present even after the anodic operation in an aqueous electrolyte, which confirms the high stability of QNi as a protection layer.

### Experimental Example 7: Analysis of Surface Catalyst Activity According to Introduction of Organic Material-Metal Complex Thin Film Layer

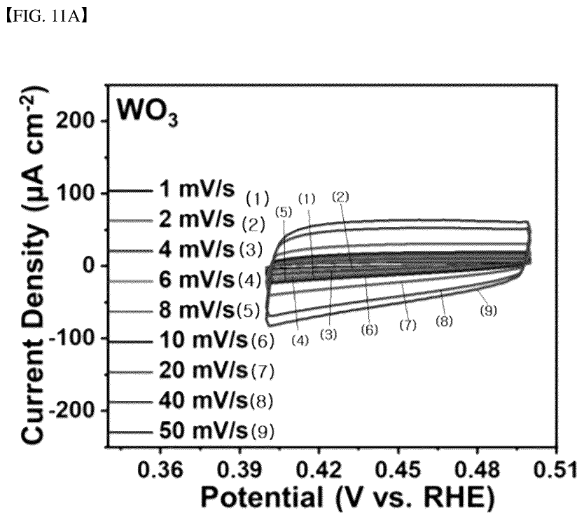

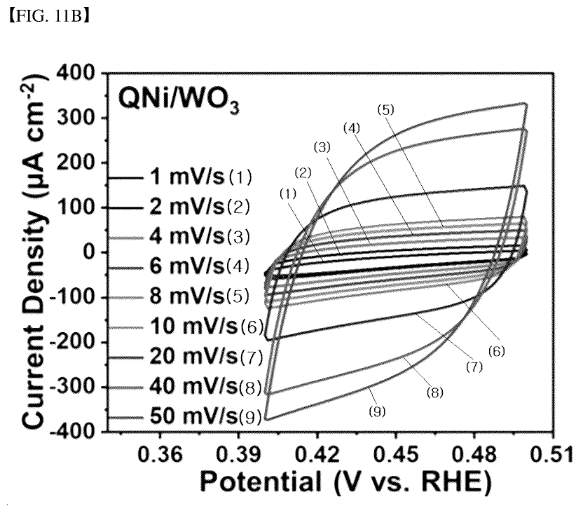

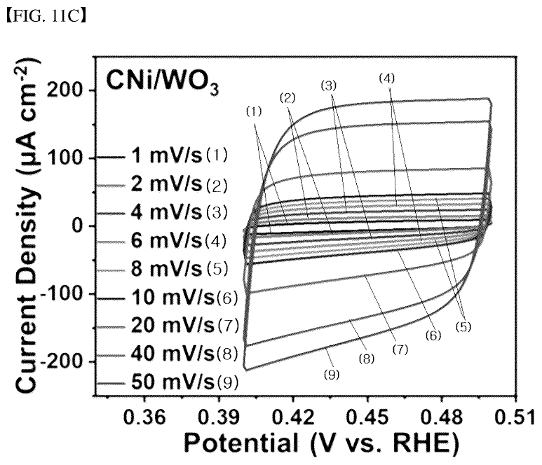

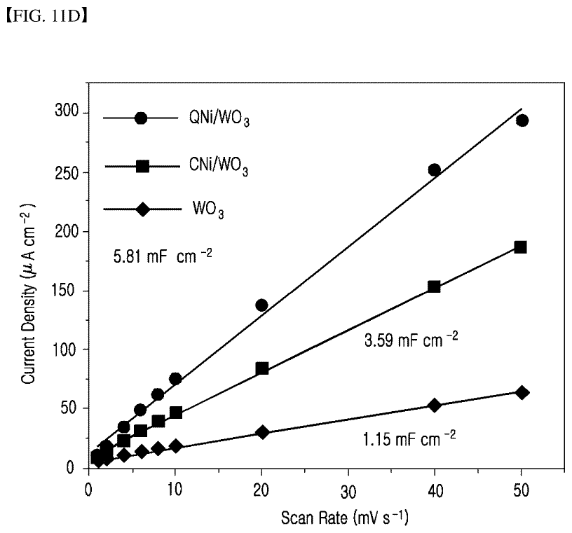

FIGS. 11A, 11B, 11C, and 11D are each an example view showing the electrochemical active surface area analysis for WO₃, QNi/WO₃, and CNi/WO₃ electrodes.

FIGS. 11A, 11B, 11C, and 11D are analysis graphs respectively for the current density analysis for WO₃ according to the scanning rate, the current density analysis for QNi/WO₃ according to the scanning rate, the current density analysis for CNi/WO₃ according to the scanning rate, and the active surface area (electrical capacity per unit area) analysis for WO₃, QNi/WO₃, and CNi/WO₃ electrodes.

This Experimental Example 7 is the result of analyzing the electrochemical active surface area (ECSA) through current density in non-Faradaic region according to the scanning rate for the produced WO₃, CNi/WO₃, and QNi/WO₃.

Referring to FIG. 11, the active surface area of the material may be greatly improved by introducing the organic metal composite thin film. This is a result confirming that the organic metal composite thin film may control the surface active site of the material.

### Experimental Example 8: Device Implementation and Performance Analysis with Organic Material-Metal Complex Thin Film Layer Introduced Thereto

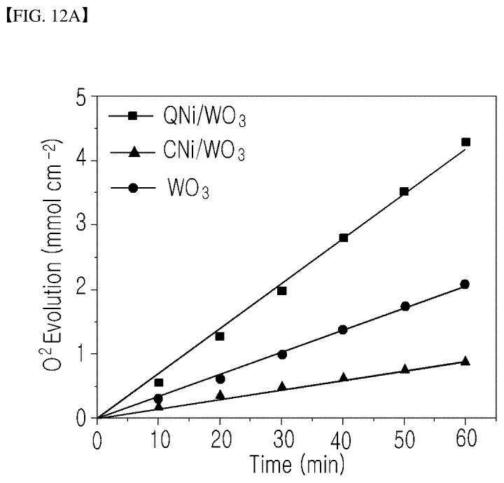

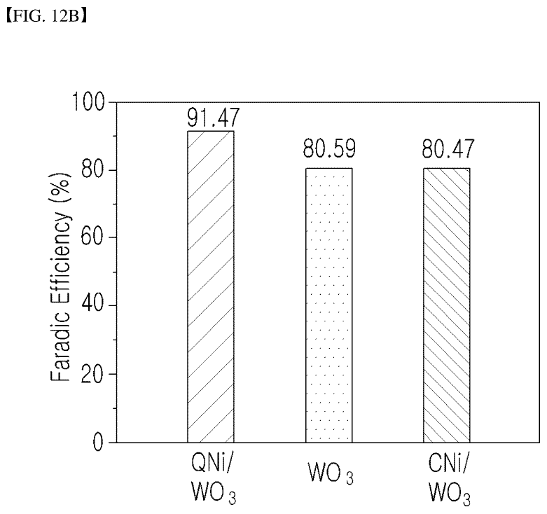

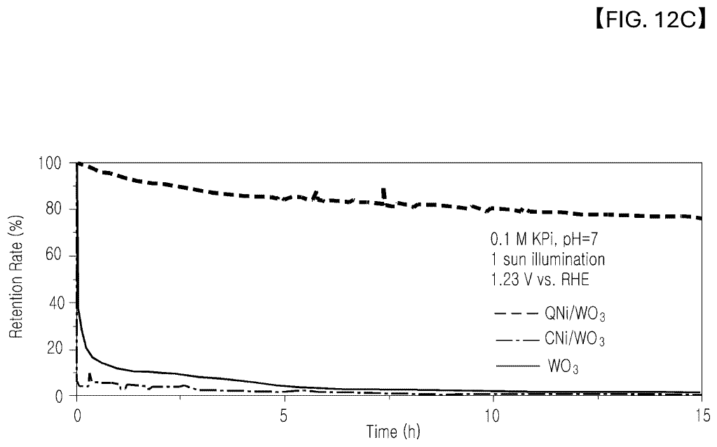

FIGS. 12A, 12B, and 12C are each an example view showing the performance analysis of a water electrolysis reaction under light irradiation conditions of WO₃, QNi/WO₃, and CNi/WO₃.

FIG. 12A shows the results of analyzing the oxygen production amount through photoelectrochemical water oxidation according to time for each electrode, FIG. 12B shows the results of analyzing the Faraday efficiency for each electrode, and FIG. 12C shows the results of evaluating the long-term operation stability through the analysis of the time-relative current change for each electrode.

This Experimental Example 8 is an application case of WO₃, CNi/WO₃, and QNi/WO₃ with the previously produced organic material-metal complex thin film introduced thereto, wherein a water electrolysis device was implemented and a performance evaluation thereon was performed.

Referring to FIGS. 12A, 12B, and 12C, QNi/WO₃ may exhibit the superior oxygen production amount and Faraday efficiency compared to WO₃ and CNi/WO₃. It was found that these performance changes were due to the improvement of charge transfer and charge transport due to the improvement of optical and electrical properties and surface activity.

In addition, it was confirmed that the excellent catalytic activity of QNi/WO₃ with the organic metal composite thin film introduced thereto greatly improved the operating stability along with the improvement of water electrolysis performance.

The above description of the disclosure is for illustrative purposes, and those skilled in the art will understand that it can be easily modified into other specific forms without changing the technical idea or essential features of the disclosure. Therefore, it should be understood that the embodiments described above are exemplary in all respects and not limiting. For example, each component described as a single type may be implemented in a distributed manner, and likewise, components described as distributed may be implemented in a combined form.

The scope of the disclosure is indicated by the following claims, and all changes or modified forms derived from the meaning and scope of the claims and their equivalent concepts should be interpreted as being included in the scope of the disclosure.

What is claimed is:

1. An organic-metal composite thin film photoelectrode comprising:
a substrate;
a photoelectrode layer positioned on the substrate and composed of a semiconducting metal compound; and
a protection layer positioned on the photoelectrode layer and including a natural molecule-derived organic material-metal complex uniformly deposited thereon,
wherein the photoelectrode layer and the protection layer are chemically bonded.

2. The organic-metal composite thin film photoelectrode of claim 1, wherein the semiconducting metal compound comprises a metal oxide, a metal nitride, a metal carbide or a metal sulfide.

3. The organic-metal composite thin film photoelectrode of claim 2, wherein the metal oxide comprises WO₃, TiO₂, Fe₂O₃ or BiVO₄.

4. The organic-metal composite thin film photoelectrode of claim 2, wherein the metal nitride comprises Ta₃N₅, GaN or InN.

5. The organic-metal composite thin film photoelectrode of claim 2, wherein the metal carbide comprises Ti₃C₂, Mo₂C or W₂C.

6. The organic-metal composite thin film photoelectrode of claim 2, wherein the metal sulfide comprises ZnS, MoS₂, CuS or CdS.

7. The organic-metal composite thin film photoelectrode of claim 1, wherein the natural molecule-derived organic material-metal complex is a nanostructure in which the natural molecule-derived organic material and a positive metal ion are self-assembled through coordination bonding.

8. The organic-metal composite thin film photoelectrode of claim 1, wherein the natural molecule-derived organic material comprises quercetin, epigallocatechin gallate, alliin or curcumin.

9. The organic-metal composite thin film photoelectrode of claim 1, wherein the metal comprises nickel (Ni), cobalt (Co), iron (Fe) or zinc (Zn).

10. A method for producing an organic-metal complex thin film photoelectrode, comprising:
depositing a photoelectrode layer by performing a sol-gel method on a substrate; and
uniformly applying a natural molecule-derived organic material-metal complex on the photoelectrode layer to form a protection layer.

11. The method of claim 10, wherein in the depositing of the photoelectrode layer, the photoelectrode layer comprises a metal oxide, a metal nitride, a metal carbide or a metal sulfide.

12. The method of claim 10, wherein in the depositing of the photoelectrode layer, the metal oxide comprises WO₃, TiO₂, Fe₂O₃ or BiVO₄.

13. The method of claim 10, wherein in the depositing of the photoelectrode layer, the metal nitride comprises Ta₃N₅, GaN or InN.

14. The method of claim 10, wherein in the depositing of the photoelectrode layer, the metal carbide comprises Ti₃C₂, Mo₂C or W₂C.

15. The method of claim 10, wherein in the depositing of the photoelectrode layer, the metal sulfide comprises ZnS, MoS₂, CuS or CdS.

16. The method of claim 10, wherein in the forming of the protection layer, a solution containing the natural molecule-derived organic material-metal complex is dropped onto the photoelectrode layer and then dried for a preset time.

17. The method of claim 10, wherein the natural molecule-derived organic material comprises quercetin, epigallocatechin gallate, alliin or curcumin.

18. The method of claim 10, wherein the metal comprises nickel (Ni), cobalt (Co), iron (Fe) or zinc (Zn).
